(19) United States
(12) Patent Application Publication
(10) Pub. No.: US 2019/0255831 A1
(43) Pub. Date: Aug. 22, 2019

(54) METHOD OF ATTACHING RESIN FILM AND METHOD OF MANUFACTURING LIQUID EJECTION HEAD

(71) Applicant: CANON KABUSHIKI KAISHA, Tokyo (JP)

(72) Inventors: Tetsushi Ishikawa, Tokyo (JP); Manabu Otsuka, Kawasaki-shi (JP)

(21) Appl. No.: 16/273,362

(22) Filed: Feb. 12, 2019

(30) Foreign Application Priority Data
Feb. 22, 2018 (JP) 2018-029875

(51) Int. Cl. B32B 37/00; B29C 65/02; B29C 65/00; B32B 27/08; B41J 2/16

(52) U.S. Cl. CPC B32B 37/0046; B32B 37/0023; B41J 2/1623; B29C 66/723; B32B 27/08; B29C 65/02

(57) ABSTRACT

A resin film laminated on a support film is attached to the surface of a substrate having a pattern of unevenness. Firstly, the substrate is placed on a stage with the surface side up. Secondly, the resin film is placed so as to face the surface of the substrate and the surface is scanned with a roller while the resin film is pressed against the surface from the side of the support film to bring them into contact with each other. Surface temperatures of the stage and the roller are set to form a temperature gradient such that the temperature of the surface of the resin film to be attached to the surface of the substrate becomes not lower than the softening temperature of the resin film and the temperature of the surface of the support film side becomes lower than the softening temperature of the resin film.

### BACKGROUND OF THE INVENTION

### Field of the Invention

The present invention relates to a method of attaching a resin film and a method of manufacturing a liquid ejection head by using the attaching method.

### Description of the Related Art

Liquid ejection recording apparatuses (liquid ejection apparatuses) represented by ink jet recording apparatuses carry out recording by ejecting recording liquid droplets to force them to fly from ejection orifices of their liquid ejection head and land onto a recording medium.

The constitution of such a liquid ejection head will next be described. As shown in FIG. 5B, the liquid ejection head has a silicon substrate (substrate) 1 having, on a surface thereof, an electrical wiring, a plurality of energy generating elements 2 configured to generate energy for ejecting a liquid (hereinafter referred to as “ink” in the description) and the like. The silicon substrate carries thereon an ejection orifice forming member 20 having a plurality of ejection orifices 5.

The ejection orifice forming member 20 includes bubbling chambers 10 each of which stores an ink and generates an air bubble therein by means of an energy generating element 2 and a minute ejection orifice 5 for ejecting ink droplets. The silicon substrate 1 is, in addition, equipped with a liquid supply path or liquid supply paths each running through the substrate from the surface to the back surface thereof and each liquid supply path is comprised of a plurality of ink supply ports 6 (individual supply ports) that are opened on the surface side and a common liquid chamber 3 that is associated with the ink supply ports and is opened on the back surface side of the substrate. The silicon substrate 1 has, on the bottom surface (back surface) side thereof, a flow path member 7 serving as a lid member of the common liquid chamber 3. Ink is supplied to the bubbling chamber 10 from the outside through the common liquid chamber 3 and the ink supply ports 6.

The ink, after filling the bubbling chamber 10 therewith, is pushed out in a direction almost orthogonal to the silicon substrate by air bubbles produced by film boiling caused by the ejection energy generating element 2 and ink droplets are ejected from the ejection orifices 5.

The ejection orifice forming member 20 having such a constitution can be obtained, for example, by attaching a resist film to a silicon substrate and forming the bubbling chambers 10 and the ejection orifices 5 by photolithography. The flow path member 7 on the back surface side of the silicon substrate 1 can be obtained similarly by attaching a resist film thereto and making the opening portion(s) by photolithography.

Japanese Patent Application Laid-Open No. 2008-000963 discloses a method of, during formation of a precise fine space or spaces, providing a film serving as a top board on a substrate having a precise fine recess or recesses while controlling the pressure, per unit contact area, of a contact portion or portions between the substrate and the film to be constant. According to this document, the film can be prevented from entering the precise fine recess or recesses. There is also disclosed a method of fixing, as a film, a dried resist film by applying heat and pressure by a lamination method and forming a precise fine space by photolithography including exposure, PEB and development.

According to Japanese Patent Application Laid-Open No. 2008-000963, the dried resist film (resin film) is fixed to the substrate by applying heat and pressure by a lamination method and is thus provided on (or attached onto) the substrate. In this case, the film is heated by both a stage which heats the substrate and a roller which heats the film. When the temperature of the resist film is too low, the film does not adhere to the substrate. On the contrary, when the temperature is too high, the film thus laminated inevitably has a deteriorated surface shape. Thus, there occurs a trade-off problem. In addition, the dried resist film has a resin film on a base film. Usually, after the surface of the resin film to be bonded to the substrate is bonded under pressure to the substrate from above the base film by a roller or the like, the base film is released. At this time, when the temperature at the time of bonding is also high on the surface of the resin film to be released from the base film, that is, the surface of the resin film opposite to the bonded surface, the resin film may have a deteriorated surface shape after releasing. When the dried resist film is used for the formation of a flow path member or an ejection orifice forming member of a liquid ejection head, such insufficient attachment or deterioration in surface shape may particularly become a problem.

### SUMMARY OF THE INVENTION

In one aspect of the invention, there is provided a method of attaching a resin film laminated on a support film onto a surface of a substrate having a pattern of unevenness by means of a roller. The method includes a step of placing the substrate on a stage with the surface side up and a step of placing the resin film so as to face the surface of the substrate placed on the stage and scanning the surface with the roller while pressing the resin film against the surface from the side of the support film to bring the film into contact with the surface and stick the resin film to the surface of the substrate by means of the roller. In this method, a surface temperature of the stage and a surface temperature of the roller are set to form a temperature gradient such that a temperature of a first surface of the resin film to be attached to the surface of the substrate becomes a softening temperature of the resin film or higher and a temperature of a second surface of the resin film to be brought into contact with the support film becomes lower than the softening temperature of the resin film.

In the other aspect of the invention, there is provided a method of manufacturing a liquid ejection head by using the above-described method of attaching a resin film.

Further features of the present invention will become apparent from the following description of exemplary embodiments with reference to the attached drawings.

### BRIEF DESCRIPTION OF THE DRAWINGS

FIGS. 1A, 1B, 1C and 1D are each a schematic view showing a step of attaching a resist film to a substrate.

FIGS. 2A, 2B and 2C are each a schematic view showing a desirable or undesirable state after the resist film is attached.

FIG. 3 shows a temperature profile in a dry film in First Embodiment of the invention.

FIG. 4 shows a temperature profile in a dry film in Third Embodiment of the invention.

FIGS. 5A and 5B are a schematic plan view and a cross-sectional perspective view of a liquid ejection head, respectively, obtained by the manufacturing method of the related art or the embodiment of the invention.

FIGS. 6A, 6B, 6C, 6D, 6E, 6F, 6G, 6H and 6I are each a schematic cross-sectional view showing the manufacturing method of the embodiment of the invention.

### DESCRIPTION OF THE EMBODIMENTS

An object of the invention is to provide a resin film attaching method capable of attaching a resin film to a substrate reliably and at the same time, attaching without causing a change in the surface shape of both surfaces of the resin film and a method of manufacturing a liquid ejection head by using the resin film attaching method.

Embodiments of the invention will hereinafter be described referring to some drawings.

### First Embodiment

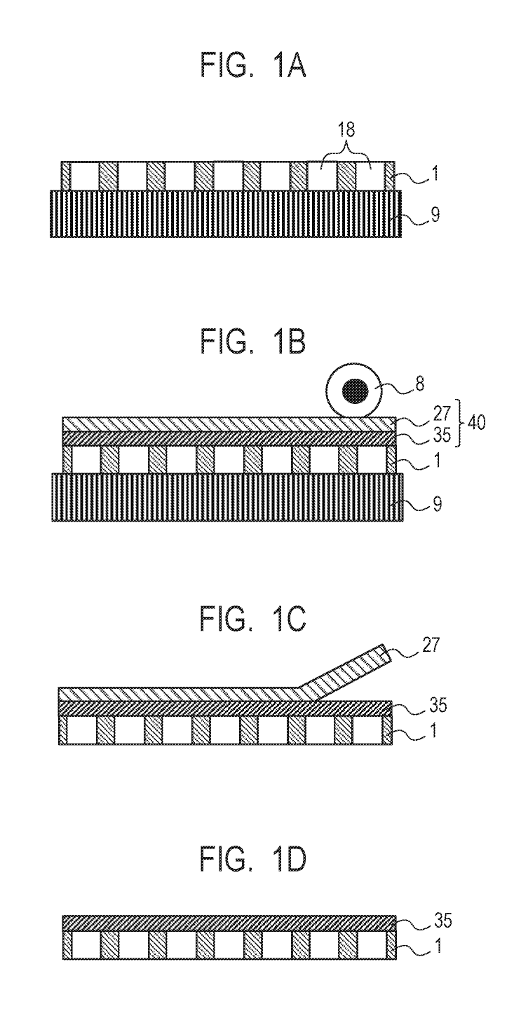

FIGS. 1A to 1D are schematic views each showing a step of attaching, to a substrate 1 having therein a plurality of through-holes 18 formed by precise fine processing, a dry film 40 comprised of a base film 27 and a resist film 35 applied to the surface thereof and then releasing the base film 27. The dry film is a laminated film and a resist film obtained by application and solidification of a liquid resist or the like is laminated on a flexible support film (base film). The base film is released after attachment of the resist film. This step will next be described more specifically. As shown in FIG. 1A, a substrate 1 is placed on a heatable stage 9, with the surface to be attached up. Next, as shown in FIG. 1B, the dry film 40 is placed on the substrate 1 so that the surface of the dry film 40 to be attached (first surface) faces the substrate 1. By using a laminator having a heatable transfer roller (which will hereinafter be described “roller” simply) 8, lamination is performed while applying heat and pressure. More specifically, the dry film 40 is pressed and scanned from the side of the base film 27 by a heated roller 8 to stick to the surface of the substrate 1 while it is brought into contact with the surface of the substrate 1 to be attached. At this time, the surface temperature of the roller 8 and the surface temperature of the stage 9 are set in advance to satisfy the predetermined condition (which will be described later). Next, as shown in FIG. 1C, the base film 27 is released to obtain the substrate 1 to which the resist film 35 has been attached as shown in FIG. 1D. FIGS. 1A to 1D show the substrate 1 having a through-hole penetrating from the surface to the back surface, but instead, a plurality of patterns of unevenness may each be a recess obtained only by digging the substrate 1 from the surface side. FIG. 1B shows a method of placing the dry film 40 on the substrate 1 in advance and then scanning it with the roller 8. The attaching method is not limited to it but instead, it may be a method of attaching the dry film 40, which is suspended above the substrate 1 to prevent the contact therebetween, while pressing the dry film with the roller 8 to bring it into contact with the substrate 1 and scanning the dry film.

The dry film 40 can be obtained, for example, by applying a material of the resist film 35 onto the base film 27 by spin coating, slit coating, or the like and solidifying it into a film having a thickness of from 5 μm to 200 μm. As the material of the resist film 35, for example, a negative photosensitive resin can be used. Examples of it include negative photosensitive resins making use of a radical polymerization reaction and negative photosensitive resins making use of a cationic polymerization reaction. The negative photosensitive resins may be used either singly or in combination as a mixture. If necessary, an additive and the like may be added as needed. As the negative photosensitive resin, usable are commercially available ones such as “SU-8 series” and “KMPR-1000” (each, trade name; product of Nippon Kayaku) and “TMMR 52000” (product of Tokyo Ohka Kogyo).

As the base film 27, a film made of an olefin resin such as PET, polyimide, polyethylene or polypropylene is used. The surface of the base film 27 on which the resist film 35 is to be formed may be subjected to release treatment to facilitate release of it from the resist film 35. A commercially available product in the form of a dry film such as “TMMF 52000” series (trade name; product of Tokyo Ohka Kogyo) may be used. Such a commercially available dry film has, on the surface to be attached, a cover film and this cover film is used after being released at the time of attachment.

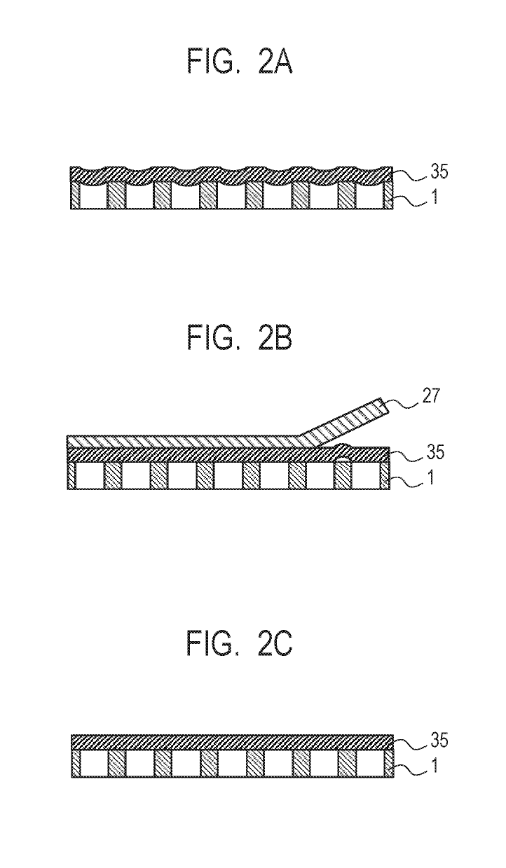

When the dry film 40 is attached to the substrate by pressing and bringing it into contact therewith (pressing against the substrate) by means of a roller as shown in FIG. 1B, the surface temperature of the stage 9 on which the substrate 1 is placed and the surface temperature of the roller 8 are important. The respective surface temperatures of the stage 9 and the roller 8 increased to the softening temperature of the resist film 35 or more fluidize the surface of the resulting structure from which the base film 27 has been released due to excessive softening of the resist film 35 and the structure has a deteriorated surface shape as shown in FIG. 2A. On the other hand, the respective surface temperatures of the stage 9 and the roller 8 lower than the softening temperature cause neither softening nor adhesion of the resist film 35. In this case, when the base film 27 is released, the resist film 35 floats from the substrate 1, being released therefrom as shown in FIG. 2B. As shown in FIG. 2C, it is necessary to prevent release of the resist film 35 and achieve good flatness. The term “softening temperature of the resist film” means a softening temperature of a photosensitive resin before exposure (crosslink).

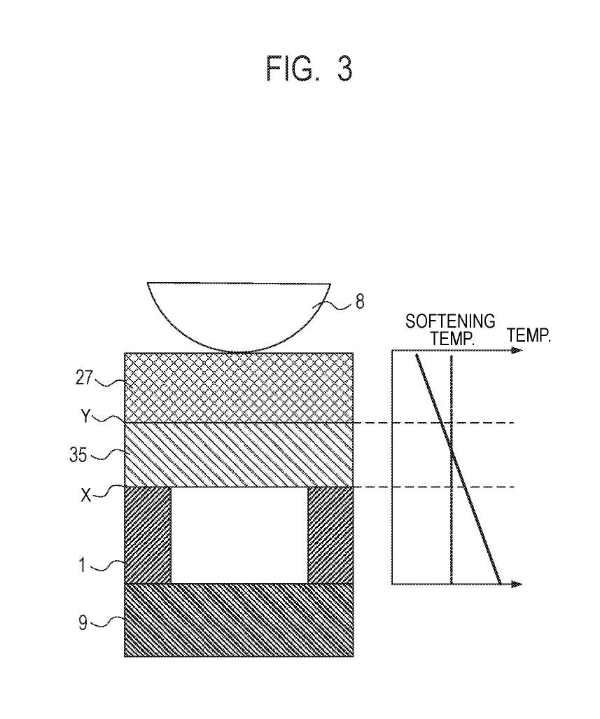

FIG. 3 is a schematic view showing the relationship between an enlarged cross-section of a portion of the substrate 1 to which the resist film 35 with the base film 27 has been attached and a temperature gradient in the thickness direction. The resist film 35 sticks to the substrate 1 by setting the surface temperature of the stage 9 on which the substrate 1 is to be placed higher than the softening temperature of the resist film 35, setting the surface temperature of the roller 8 lower than the softening temperature of the resist film 35 and then rolling the roller 8 while pressing it against the base film 27 (which may also be called “scanning”). Adhesiveness at an interface X between the resist film 35 and the substrate 1 should be kept to prevent occurrence of inconvenience such as exfoliation in a subsequent base film releasing step. The temperature of the first surface (on the side of the interface X) of the resist film 35 should be the softening temperature or higher to enable softening and adhesion of the resist film 35. Temperatures much higher than the softening temperature may cause deformation and deterioration of the surface so that the temperature should be suppressed to fall within an adequate range.

The second surface (on the side of the interface Y) of the resist film 35 which will be a surface of the structure obtained after release of the base film 27 has preferably a temperature lower than the softening temperature in order to prevent the second surface from softening and thereby flowing to cause deterioration of the surface shape. In other words, the surface temperature of the roller 8 and the surface temperature of the stage 9 are preferably set to show a gradual decrease from the side of the stage 9 toward the side of the roller 8 inside the resist film 35. More specifically, the surface temperature of the roller 8 and the surface temperature of the stage 9 are preferably set to form a temperature gradient at which the temperature of the first surface of the resist film 35 becomes the softening temperature of the resin film or higher and the temperature of the second surface of the resist film becomes lower than the softening temperature of the resin film. In short, conditions such as the surface temperature of the roller 8 and the surface temperature of the stage 9 are preferably set so that the temperature profile crosses the softening temperature inside the resist film 35.

As one method to realize the above-described state, the surface temperature of the stage 9 which is contact with the substrate 1 is made higher than the softening temperature of the resist film 35. When the resist film 35 has a softening temperature of from 35° C. to 45° C. (more specifically, 40° C.), the surface temperature of the material is set at, for example, from 45° C. to 80° C. and the surface temperature of the roller 8 near the second surface of the resist film 35 is set lower than the softening temperature, though depending on the material. It is, for example, from −15° C. to 35° C. The surface temperature of the stage 9 is preferably higher by 5° C. or more than that of the roller 8. The advantage of the present embodiment is exhibited more when a substrate having a low surface energy and a pure water contact angle of, for example, 60° or more is used as the substrate 1. An influence of a roller pressure is presumed to be relatively small.

### Second Embodiment

As in First Embodiment, a substrate 1 subjected to precise fine processing was placed on a stage 9 (FIG. 1A) and a dry film 40 is attached onto the substrate 1 (FIG. 1B). In Second Embodiment, both the surface temperature of the stage 9 and the surface temperature of the roller 8 are set at 45° C., a temperature higher than the softening temperature of the resist film 35. The roller (transfer) speed is however increased to suppress heat conduction to the interface Y. The roller speed is preferably, for example, 5 mm/s or more (refer to Example 2). The surface of the roller 8 is preferably made of a material having a low thermal conductivity, for example, 0.3 W/m·K or less. Examples include a silicone rubber, a butyl rubber, a nitrile rubber and a urethane rubber. Using such a film can reduce the thermal conduction to the interface Y, resulting in that the temperature of the second surface of the resist film 35 becomes lower than the softening temperature of the resist film 35.

### Third Embodiment

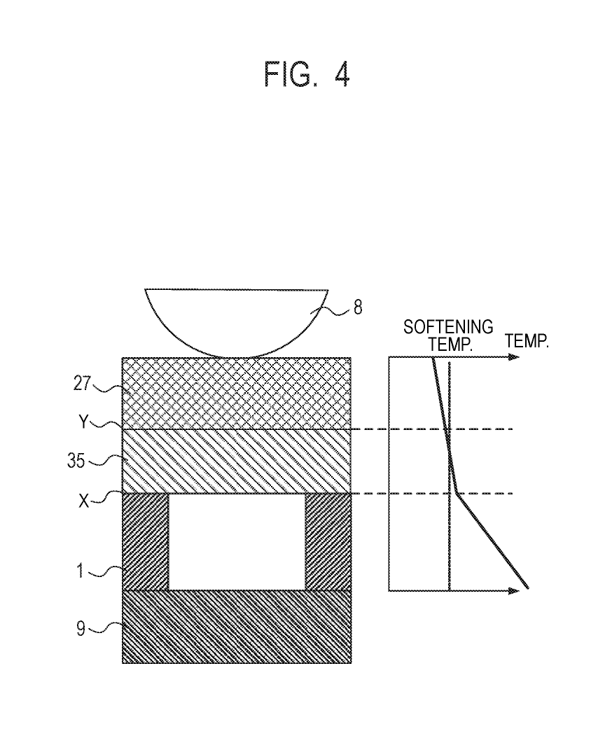

When the resist film 35 is attached to the substrate 1 subjected to precise fine processing, a base film 27 made of a material having a low thermal conductivity is preferred. More specifically, the base film 27 has preferably a thermal conductivity of 0.3 W/m·K or less. Examples of the material of the base film include PET, polyimide and hydrocarbon-based films. The base film is preferably as thick as, for example, from 50 to 500 μm. As a result, as shown in FIG. 4, this makes it possible to make the temperature of the second surface of the resist film 35 lower than the softening temperature of the resist film 35 because even if the surface temperature of the roller 8 is the softening temperature or higher, the surface temperature of the base film 27 to be brought into contact with the roller is lower than the surface temperature of the roller 8 and at the same time, has a small thermal conductivity to the interface Y.

### EXAMPLES

A method of manufacturing a liquid ejection head will next be described as one using example of the method of attaching a resin film of the invention, but the invention is not limited only to the manufacture of a liquid ejection head.

### Example 1

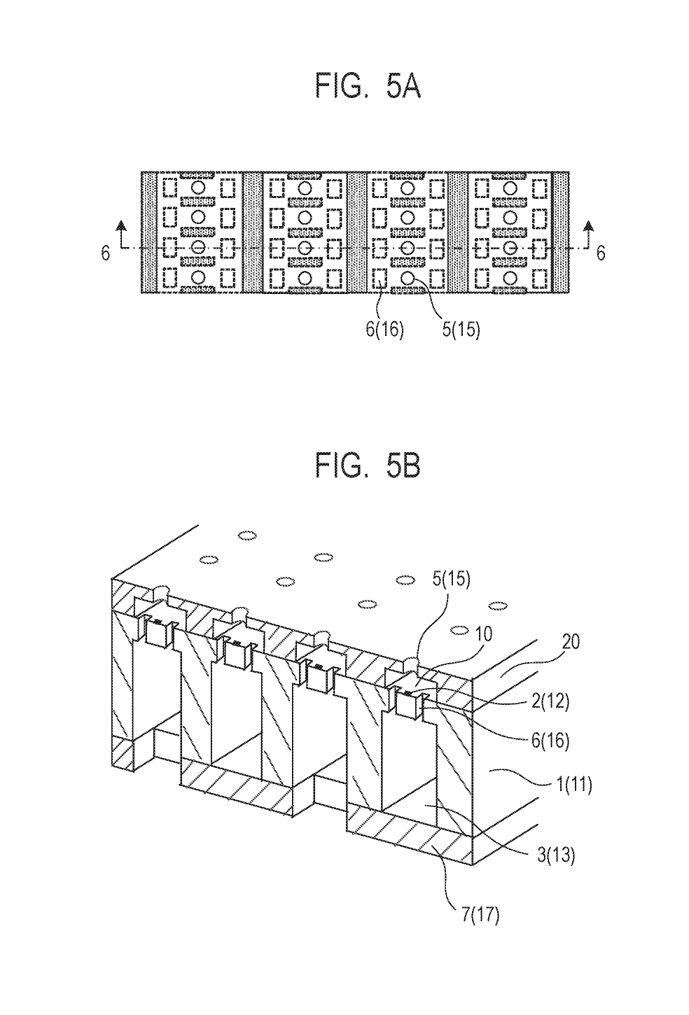

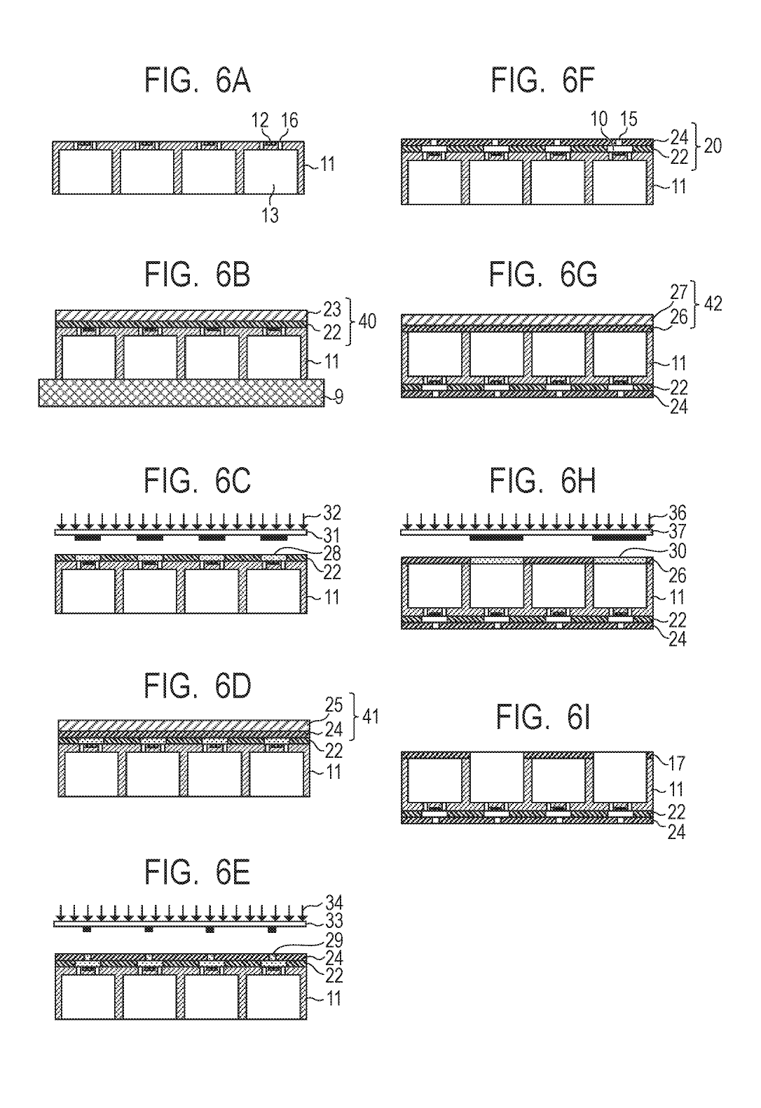

The liquid ejection head shown in FIGS. 5A and 5B was manufactured using the above-described resin film attaching method. Specific manufacturing steps of the liquid ejection head will hereinafter be described referring to FIGS. 6A to 6I. FIGS. 6A to 6I show the cross-section taken along the line 6-6 of FIG. 5A.

First, as shown in FIG. 6A, an ejection energy generating element 12 and a semiconductor element (not shown) for driving and controlling it were provided on a semiconductor substrate 11. In the substrate 11, a 400-μm deep and 200-μm wide common liquid chamber 13 and an ink supply port 16 were made by photolithography and Si deep etching.

A dry film 40 obtained by applying an epoxy resin (including “N-695”, product of Dainippon Ink) which would be a photosensitive resin (resin film) 22 onto a base film 23 made of PET by spin coating was prepared in advance. The respective sensitivities of the first photosensitive resin 22 and a second photosensitive resin 24 which will be described later have already been adjusted to permit selective exposure patterning. The first photosensitive resin 22 had a softening temperature of 70° C. and had a thickness of 15 μm.

Next, as shown in FIG. 6B, the substrate 11 was placed on the stage 9, followed by placing the dry film 40 to bring the first photosensitive resin 22 into contact with the substrate 11. By a laminator (not shown) having a roller, the dry film 40 was scanned. The scanning was performed under the following conditions: stage surface temperature of 75° C., roller surface temperature of 60° C., roller pressure of 0.2 MPa and roller speed of 5 mm/s. By satisfying the above conditions, both the adhesiveness between the first photosensitive resin 22 and the substrate 11 and flatness of both surfaces can be satisfied. After attachment of the first photosensitive resin 22, the base film 23 was released from the dry film 40.

Then, as shown in FIG. 6C, pattern exposure with a 365-nm exposure light 32 was performed through a mask 31 at an exposure energy of 5000 J/m² by a stepper. Then, post bake was performed at 50° C. to form a latent image so that an un-exposed portion 28 of the first photosensitive resin 22 became a bubbling chamber.

A dry film 41 obtained by applying an epoxy resin (including “157S70”, product of Japan Epoxy Resin (JER) as a part of Mitsubishi Chemical) which would be a second photosensitive resin 24 onto a PET film which would be a base film 25 was prepared in advance. As shown in FIG. 6D, the dry film 41 was then attached by a laminator so as to bring the second photosensitive resin 24 into contact with the first photosensitive resin 22. Attachment was performed under the following conditions: stage surface temperature and roller surface temperature: 50° C., roller pressure: 0.2 MPa and roller speed: 5 mm/s. The base film 25 was then released from the dry film 41.

Then, as shown in FIG. 6E, pattern exposure with an exposure light 34 having an exposure wavelength of 365 nm was performed through a mask 33 at an exposure energy of 1000 J/m² by a stepper. Post bake was performed at 90° C. to form a latent image so that an un-exposed portion 29 of the second photosensitive resin 24 became an ink ejection orifice. By development with propylene glycol 1-monomethyl ether 2-acetate (PGMEA), an ink ejection orifice 15 and a bubbling chamber 10 were then formed as shown in FIG. 6F. Thus, an ejection orifice forming member 20 was formed by laminating the second photosensitive resin 24 on the first photosensitive resin 22 and forming therein the ink ejection orifice 15 and the bubbling chamber 10.

A dry film 42 obtained by applying TMMF (product of Tokyo Ohka Kogyo) which would be a third photosensitive resin (resin film) 26 onto a base film 27 made of PET was prepared in advance. The third photosensitive resin 26 has a softening temperature of about 40° C.

As shown in FIG. 6G, the substrate 11 was reversed and the dry film 42 was attached to the back surface of the substrate by a laminator to bring the third photosensitive resin 26 into contact with the substrate 11. The attachment was performed under the following conditions: surface temperature of the stage 9: 45° C., surface temperature of the roller 8: 30° C., roller pressure: 0.2 MPa and roller speed: 5 mm/s. Such conditions make it possible to satisfy both the adhesiveness between the third photosensitive resin 26 and the substrate 11 and flatness of both surfaces. Then, the base film 27 was released.

Then, as shown in FIG. 6H, after pattern exposure with an exposure light 36 through a mask 37 at an exposure energy of 400 mJ/cm² by an i-line stepper capable of back alignment, post baking was performed at 90° C. Further, after formation of an opening portion by developing an un-exposed portion 30 with PGMEA, a step of curing at 200° C. for one hour was performed. In such a manner, a flow path member 17 was formed by attaching the third photosensitive resin 26 to the back surface of the substrate 11, followed by processing (FIG. 6I).

It was confirmed that with respect to the back surface of the substrate 11, the third photosensitive resin 26 adhered sufficiently to the substrate 11 without floating after the base film 27 was released. With respect to the surface shape of the third photosensitive resin 26 (the uppermost surface in FIG. 6I), the unevenness amount was within 10 μm, suggesting that a liquid ejection head thus manufactured had a flat surface. The unevenness amount of the surface of the third photosensitive resin 26 was measured with a white interferometer.

Table 1 shows the evaluation results of the adhesiveness of the third photosensitive resin 26 (dry film 42) and the surface shape thereof obtained by making a test while changing, among the above-described attachment conditions, only those for the third photosensitive resin, that is, the respective surface temperatures of the stage 8 and the roller 9. Evaluation criteria for adhesiveness were as follows: A: no floating (good), B: floating at several places (acceptable) and C: floating at more than ten places (unacceptable). Evaluation criteria for surface shape (unevenness amount) were as follows: A: 10 μm or less (good), B: from 10 to 15 μm (acceptable) and C: 15 μm or more (unacceptable).

TABLE 1

| | | Stage surface temperature | | | | |
|---|---|---|---|---|---|---|
| | | 30° C. | 35° C. | 40° C. | 45° C. | 50° C. |
| Roller surface | 30° C. | C/A | C/A | B/A | A/A | A/A |
| temperature | 35° C. | C/A | C/A | B/A | A/A | A/A |
| | 40° C. | C/B | C/B | B/B | A/B | A/B |
| | 45° C. | C/C | C/C | B/C | A/C | A/C |
| | 50° C. | C/C | C/C | B/C | A/C | A/C |

### (Evaluation: Adhesiveness/Surface Shape)

It is apparent from Table 1 that the roller surface temperature higher than the softening temperature of the third photosensitive resin, that is, 40° C. (data at 45° C. or higher), deteriorates the surface shape. It is also apparent that the stage surface temperature lower than the softening temperature, that is, 40° C. (data at 35° C. or lower) deteriorates the adhesiveness to the substrate. This has revealed that it is preferred to set the roller surface temperature at the softening temperature or lower and the stage surface temperature at the softening temperature or higher. For example, when a resin film having a softening temperature of 40° C. is used, it is preferred to set the roller surface temperature to from 30° C. to 40° C. and the stage surface temperature to from 40° C. to 50° C.

### Example 2

By Si deep etching of a substrate 11 provided with an ejection energy generating element 12 as in Example 1, a common liquid chamber 13 and an ink supply port 16 were formed and further, an ejection orifice forming member 20 was formed. Then, in a step of laminating a third photosensitive resin layer 26 with the back surface of the substrate 11, the third photosensitive resin layer was attached under the conditions of a stage surface temperature of 45° C., a roller surface temperature of 45° C., a roller pressure of 0.2 MPa and a roller speed of 10 mm/s. Although the roller surface temperature was 45° C. and was higher than the softening temperature of the third photosensitive resin layer 26, not only adhesiveness to the substrate but also flatness could be secured simultaneously in the liquid ejection head manufactured under the above-described conditions by setting the roller speed higher than that in Example 1 under the same temperature conditions.

### Comparative Example 1

By Si deep etching of a substrate 11 provided with an ejection energy generating element 12 as in Example, a common liquid chamber 13 and an ink supply port 16 were formed and further, an ejection orifice forming member 20 was formed. Then, in a step of laminating a third photosensitive resin layer 26 with the back surface of the substrate 11, it was laminated under the conditions of a combination of a stage surface temperature and a roller surface temperature as shown in Table 1, a roller pressure of 0.2 MPa and a roller speed of 5 mm/s. A liquid ejection head manufactured under the conditions of a roller surface temperature of 45° C. or higher or a stage surface temperature of 35° C. or lower had poor adhesiveness to the substrate or deteriorated flatness.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-029875, filed Feb. 22, 2018, which is hereby incorporated by reference herein in its entirety.

What is claimed is:

1. A method of attaching a resin film laminated on a support film to a surface of a substrate having thereon a pattern of unevenness by means of a roller, comprising:
a step of placing the substrate on a stage with the surface side up; and
a step of placing the resin film so as to face the surface of the substrate placed on the stage and scanning the surface with the roller while pressing the resin film against the surface from the side of the support film to bring the film into contact with the surface and thereby stick the resin film to the surface by means of the roller;
wherein a surface temperature of the stage and a surface temperature of the roller are set to form a temperature gradient such that a temperature of a first surface of the resin film to be attached to the surface of the substrate becomes a softening temperature of the resin film or higher and a temperature of a second surface of the resin film to be brought into contact with the support film becomes lower than the softening temperature of the resin film.

2. The method of attaching a resin film according to claim 1, wherein the surface temperature of the stage is set higher by 5° C. or more than the surface temperature of the roller.

3. The method of attaching a resin film according to claim 1, wherein the surface temperature of the stage is set higher than the softening temperature of the resin film and the surface temperature of the roller is set lower than the softening temperature of the resin film.

4. The method of attaching a resin film according to claim 1, wherein the surface temperature of the roller is set higher than the softening temperature of the resin film and scanning is performed at a roller speed of 5 mm/s or more.

5. The method of attaching a resin film according to claim 1, wherein the resin film has a softening temperature of from 35° C. to 45° C., the surface temperature of the roller is set at from 30° C. to 40° C. and the surface temperature of the stage is set at from 40° C. to 50° C.

6. The method of attaching a resin film according to claim 1, wherein the roller has a surface made of a material having a thermal conductivity of 0.3 W/m·K or less.

7. The method of attaching a resin film according to claim 1, wherein the support film has a thickness of from 50 to 500 μm and has a thermal conductivity of 0.3 W/m·K or less.

8. The method of attaching a resin film according to claim 1, wherein the support film is a base film of a dry film; the resin film is a resist film laminated on the base film; and the method further comprises a step of attaching the resist film to the surface by bringing the roller into contact with the base film to press the roller against the base film and then releasing the base film.

9. A method of manufacturing a liquid ejection head having a plurality of energy generating elements for ejecting a liquid and a substrate equipped with a plurality of recesses formed in a back surface of the substrate for forming a plurality of common liquid chambers for supplying the liquid to the energy generating elements, comprising:
attaching a resin film to a back surface of the substrate by the attaching method as claimed in claim 1 to the back surface of the substrate to form the common liquid chambers.

10. A method of manufacturing a liquid ejection head having an ejection orifice forming member provided with a plurality of ejection orifices on a surface of a substrate having a plurality of energy generating elements for ejecting a liquid, comprising:
forming the ejection orifice forming member by attaching a resin film onto the surface of the substrate by the attaching method as claimed in claim 1.
